(19) United States
(12) Patent Application Publication
(10) Pub. No.: US 2026/0088837 A1
(43) Pub. Date: Mar. 26, 2026

(54) RADIO FREQUENCY MODULE

(71) Applicant: Murata Manufacturing Co., Ltd., Nagaokakyo-shi (JP)

(72) Inventors: Yoshihiro DAIMON, Nagaokakyo-shi (JP); Masakazu HIROBE, Nagaokakyo-shi (JP); Masaki KIMURA, Nagaokakyo-shi (JP); Takashi HIROSE, Nagaokakyo-shi (JP)

(73) Assignee: Murata Manufacturing Co., Ltd., Nagaokakyo-shi (JP)

(21) Appl. No.: 19/317,183

(22) Filed: Sep. 3, 2025

(30) Foreign Application Priority Data
Sep. 26, 2024 (JP) 2024-167819

(51) Int. Cl. H04B 1/00; H04B 1/40; H04L 5/16

(52) U.S. Cl. CPC H04B 1/0078; H04B 1/40; H04L 5/16

(57) ABSTRACT

A radio frequency module includes a first semiconductor component connected to a first digital control terminal; a second semiconductor component connected to a second digital control terminal and including first and second low-noise amplifiers; a first filter with a pass band including a TDD band; a second filter connected to the second low-noise amplifier and has a pass band including a reception band of an FDD band; a first switch circuit including a common terminal connected to an antenna connection terminal and first and second selection terminals connected, respectively, to the first and second filters; and a second switch circuit including a common terminal connected to the first filter and the third and fourth selection terminals connected, respectively, to a power amplifier and the first low-noise amplifier. The second semiconductor component is also connected to the first digital control terminal via the first semiconductor component.

### CROSS-REFERENCE TO RELATED APPLICATION

The present application claims priority to Japanese patent application JP2024-167819, filed Sep. 26, 2024, the entire contents of which being incorporated herein by reference.

### BACKGROUND

### 1. Field

The present disclosure relates to a radio frequency module.

### 2. Description of the Related Art

In mobile communication devices, such as mobile phones, with the increase in the adoption of multiband technology, there is a demand for a radio frequency module that can communicate using multiple radio frequency (RF) signals simultaneously. For example, International Publication No. 2022/018997 discloses a radio frequency (RF) circuit that can communicate using a time division duplex (TDD) band and a frequency division duplex (FDD) band simultaneously.

### SUMMARY

However, with the related-art technology described above, the reception sensitivity in the FDD band may be degraded by a transmission signal in the TDD band.

For the above reason, the present disclosure provides a radio frequency module that, in simultaneous communication using a TDD band and an FDD band, can reduce the degradation of the reception sensitivity in the FDD band.

A radio frequency module according to an aspect of the present disclosure includes a first digital control terminal; a second digital control terminal; an antenna connection terminal; a first semiconductor component connected to the first digital control terminal; a second semiconductor component that is connected to the second digital control terminal and includes a first low-noise amplifier and a second low-noise amplifier; a power amplifier; a first filter with a pass band including a TDD band; a second filter that is connected to the second low-noise amplifier and has a pass band including a reception band of an FDD band usable for simultaneous communication with the TDD band; a first switch circuit including a first common terminal connected to the antenna connection terminal, a first selection terminal connected to the first filter, and a second selection terminal connected to the second filter; and a second switch circuit including a second common terminal connected to the first filter, a third selection terminal connected to the power amplifier, and a fourth selection terminal connected to the first low-noise amplifier. The second semiconductor component is also connected to the first digital control terminal via the first semiconductor component.

A radio frequency module according to an aspect of the present disclosure includes a first digital control terminal; a second digital control terminal; an antenna connection terminal; a first semiconductor component connected to the first digital control terminal; a second semiconductor component that is connected to the second digital control terminal and includes a first low-noise amplifier and a second low-noise amplifier; a power amplifier; a first filter that is connected to the power amplifier and has a pass band including a TDD band; a second filter that is connected to the first low-noise amplifier and has a pass band including the TDD band; a third filter that is connected to the second low-noise amplifier and has a pass band including a reception band of an FDD band usable for simultaneous communication with the TDD band; and a first switch circuit including a first common terminal connected to the antenna connection terminal, a first selection terminal connected to the first filter, a second selection terminal connected to the second filter, and a third selection terminal connected to the third filter. The second semiconductor component is also connected to the first digital control terminal via the first semiconductor component.

In simultaneous communication using a TDD band and an FDD band, the present disclosure makes it possible to reduce the degradation of the reception sensitivity in the FDD band.

### BRIEF DESCRIPTION OF THE DRAWINGS

FIG. 1 is a circuit diagram of a communication device according to a first embodiment;

FIG. 2 is a diagram illustrating a first connection state of a first mode of a radio frequency module according to the first embodiment;

FIG. 3 is a diagram illustrating a second connection state of the first mode of the radio frequency module according to the first embodiment;

FIG. 4 is a diagram illustrating a second mode of the radio frequency module according to the first embodiment;

FIG. 5 is a circuit diagram of a communication device according to a second embodiment;

FIG. 6 is a diagram illustrating a first connection state of a first mode of a radio frequency module according to the second embodiment;

FIG. 7 is a diagram illustrating a second connection state of the first mode of the radio frequency module according to the second embodiment; and

FIG. 8 is a diagram illustrating a second mode of the radio frequency module according to the second embodiment.

### DETAILED DESCRIPTION

Embodiments of the present disclosure are described below in detail with reference to the drawings. Each of the embodiments described below represents a general or specific example. Values, shapes, materials, components, and layouts and connection configurations of the components described in the embodiments below are just examples and are not intended to limit the present disclosure.

Each of the drawings is a schematic diagram in which components are emphasized or omitted and the ratios between the components are adjusted to facilitate the understanding of the present disclosure. That is, components in each of the drawings are not necessarily illustrated accurately; and the shapes, positional relationships, and ratios of the components may differ from the actual shapes, positional relationships, and ratios. The same reference number is assigned to substantially the same components in the drawings, and repeated descriptions of those components may be omitted or simplified.

In the descriptions below, “connected” not only indicates that circuit elements are directly connected to each other with a connection terminal and/or a wire conductor but also indicates that the circuit elements are electrically connected to each other via another circuit element. “C is connected between A and B” indicates that one end of C is connected to A, the other end of C is connected to B, and C is disposed in series in a path between A and B. “Path between A and B” indicates a path formed by a conductor that electrically connects A to B.

“Pass band of filter” is defined as a part of a frequency spectrum transmitted by the filter and as a frequency band in which the output power is not attenuated by 3 dB or more relative to the maximum output power. That is, the pass band of a band pass filter is defined as a frequency range between two points at which the output power is attenuated by 3 dB relative to the maximum output power.

“Transmission band” refers to a frequency band used for transmission in a communication device, and “reception band” refers to a frequency band used for reception in a communication device. For example, in an FDD band, different frequency bands (an uplink band and a downlink band) are used as a transmission band and a reception band. Also, for example, in a TDD band, the same frequency band is used as the transmission band and the reception band.

“Terminal” indicates a point at which a conductor in a circuit element ends. When the impedance of a conductor between circuit elements is sufficiently low, a terminal may be interpreted not only as a specific single point but also as any point on the conductor between the circuit elements or as the entire conductor.

“Band B usable for simultaneous communication with band A” means that signals in the bands A and B can be transmitted simultaneously, can be received simultaneously, or can be transmitted and received simultaneously. Band combinations usable for simultaneous communication are predefined by standardizing bodies, such as the 3rd Generation Partnership Project (3GPP, registered trademark) and the Institute of Electrical and Electronics Engineers (IEEE). Examples of simultaneous communications include carrier aggregation (CA), E-UTRAN New Radio-Dual Connectivity (EN-DC), New Radio-Dual Connectivity (NR-DC), and New Radio E-UTRAN-Dual Connectivity (NE-DC).

### First Embodiment

A first embodiment is described below.

### 1.1. Circuit Configuration of Communication Device 5

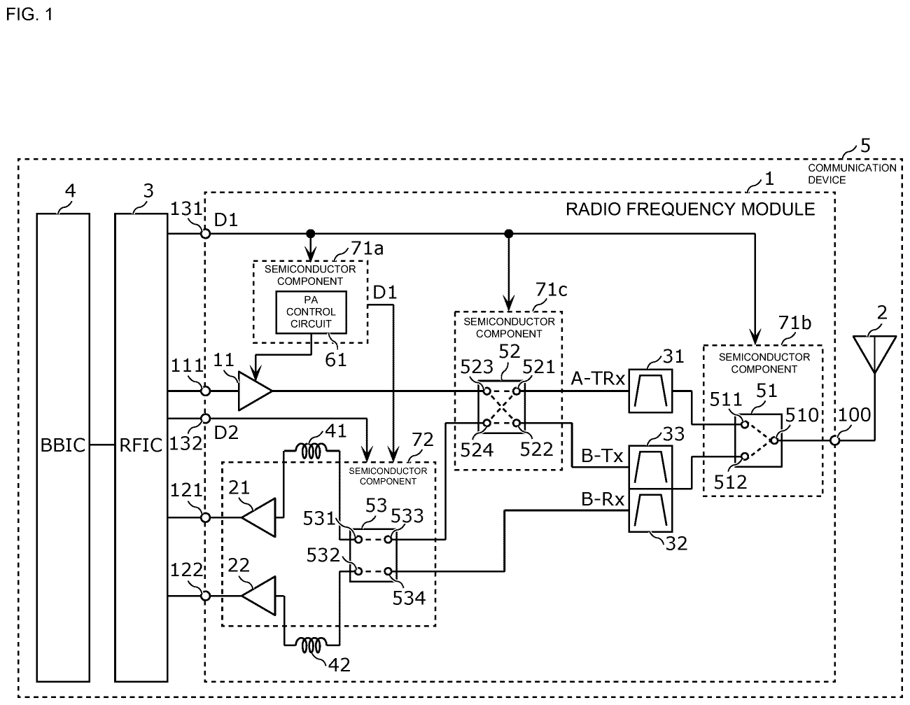

First, a circuit configuration of a communication device 5 according to the present embodiment is described with reference to FIG. 1. FIG. 1 is a circuit diagram of the communication device 5 according to the present embodiment. In FIG. 1, dotted lines in each switch circuit represent paths between terminals that are selectively connectable and disconnectable.

Here, FIG. 1 illustrates an exemplary circuit configuration, and the communication device 5 may be implemented by using any of various types of circuit implementation and circuit technologies. Therefore, the descriptions of the communication device 5 provided below are not restrictive.

The communication device 5 can be used to provide wireless connection. For example, the communication device 5 may be used for UEs, such as a mobile phone, a smartphone, a tablet computer, and a wearable device, in a cellular network (also referred to as a mobile network). As another example, the communication device 5 may be used to provide wireless connection for the Internet of Things (IoT), sensor devices, medical/healthcare devices, vehicles, unmanned aerial vehicles (UAV) (commonly known as drones), and automated guided vehicles (AGV). As still another example, the communication device 5 may be used to provide wireless connection at wireless access points or wireless hotspots.

The communication device 5 includes a radio frequency module 1, an antenna 2, a radio frequency integrated circuit (RFIC) 3, and a baseband integrated circuit (BBIC) 4.

The radio frequency module 1 is connected between the antenna 2 and the RFIC 3 and can transmit radio frequency (RF) signals between the antenna 2 and the RFIC 3. Details of the circuit configuration of the radio frequency module 1 are described later.

The antenna 2 is connected to the radio frequency module 1. The antenna 2 can receive radio frequency (RF) signals from the radio frequency module 1 and transmit the radio frequency (RF) signals to the outside of the communication device 5. Also, the antenna 2 can receive radio frequency (RF) signals from the outside of the communication device 5 and supply the radio frequency (RF) signals to the radio frequency module 1. The antenna 2 does may be separate from the communication device 5. Also, the communication device 5 may include one or more antennas in addition to the antenna 2.

The RFIC 3 is an example of a signal processing circuit that processes radio frequency (RF) signals. Specifically, the RFIC 3 can perform signal processing, such as up-converting, on a transmission signal input from the BBIC 4 and output a radio-frequency transmission signal generated by the signal processing to the radio frequency module 1. Furthermore, the RFIC 3 can perform signal processing, such as down-converting, on a radio-frequency reception signal input via a receive path of the radio frequency module 1 and output a reception signal generated by the signal processing to the BBIC 4. Also, the RFIC 3 may include a control unit that controls switch circuits and power amplifier (PA) circuits included in the radio frequency module 1. Some or all of the functions of the control unit of the RFIC 3 may be provided outside of the RFIC 3 and may be included in, for example, the BBIC 4 or the radio frequency module 1.

The BBIC 4 is a baseband signal processing circuit that performs signal processing using a frequency band lower than the frequency of radio frequency (RF) signals transmitted by the radio frequency module 1. Examples of signals processed by the BBIC 4 include an image signal for displaying an image and/or a voice signal for a call via a speaker. A part or the entirety of the BBIC 4 may be separate from in the communication device 5.

### 1.2. Circuit Configuration of Radio Frequency Module 1

Next, a circuit configuration of the radio frequency module 1 according to the present embodiment is described with reference to FIG. 1. Here, FIG. 1 illustrates an exemplary circuit configuration, and the radio frequency module 1 may be implemented by using any of various types of circuit implementation and circuit technologies. Therefore, the descriptions of the radio frequency module 1 provided below is not be restrictive.

The radio frequency module 1 includes a power amplifier (PA) 11, low-noise amplifiers 21 and 22, filters 31, 32, and 33, inductors 41 and 42, switch circuits 51, 52, and 53, an antenna connection terminal 100, a radio frequency input terminal 111, radio frequency output terminals 121 and 122, and digital control terminals 131 and 132.

The antenna connection terminal 100 is an external connection terminal of the radio frequency module 1. The antenna connection terminal 100 supplies radio frequency (RF) signals to the antenna 2 and receives radio frequency (RF) signals from the antenna 2. The antenna connection terminal 100 is connected to the antenna 2 outside of the radio frequency module 1 and is connected to the switch circuit 51 inside of the radio frequency module 1.

The radio frequency input terminal 111 is an external connection terminal of the radio frequency module 1 and receives radio frequency (RF) signals from the RFIC 3. The radio frequency input terminal 111 is connected to the RFIC 3 outside of the radio frequency module 1 and is connected to the power amplifier (PA) 11 inside of the radio frequency module 1.

The radio frequency output terminals 121 and 122 are external connection terminals of the radio frequency module 1 and supply radio frequency (RF) signals to the RFIC 3. The radio frequency output terminals 121 and 122 are connected to the RFIC 3 outside of the radio frequency module 1 and are connected, respectively, to the low-noise amplifiers 21 and 22 inside of the radio frequency module 1.

The digital control terminal 131 is an example of a first digital control terminal and is an external connection terminal of the radio frequency module 1. The digital control terminal 131 receives a digital control signal D1 from the RFIC 3. The digital control terminal 131 is connected to the RFIC 3 outside of the radio frequency module 1 and is connected to, for example, a PA control circuit 61 inside of the radio frequency module 1.

The digital control terminal 132 is an example of a second digital control terminal and is an external connection terminal of the radio frequency module 1. The digital control terminal 132 receives a digital control signal D2 from the RFIC 3. The digital control terminal 132 is connected to the RFIC 3 outside of the radio frequency module 1 and is connected to a semiconductor component 72, which includes the low-noise amplifiers 21 and 22, inside of the radio frequency module 1.

The digital control signal D1 is an example of a first digital control signal for transmission. The digital control signal D1 includes a signal for controlling the power amplifier (PA) 11 and may include, for example, a command that indicates, for each subframe, whether the transmission of a signal in a TDD band A is enabled or disabled, whether the reception of a signal in the TDD band A is enabled or disabled, or any combination of these states.

The digital control signal D2 is an example of a second digital control signal for reception. The digital control signal D2 includes signals for controlling the low-noise amplifiers 21 and 22.

Source-synchronous serial data signals may be used for the digital control signals D1 and D2. In this case, each of the digital control signals D1 and D2 includes a clock signal and a data signal, and each of the digital control terminals 131 and 132 may include a terminal for receiving the clock signal and a terminal for receiving the data signal. Alternatively, clock embedded serial data signals may be used for the digital control signals D1 and D2.

The power amplifier (PA) 11 is connected between the radio frequency input terminal 111 and the switch circuit 52. Specifically, the input end of the power amplifier (PA) 11 is connected to the radio frequency input terminal 111, and the output end of the power amplifier (PA) 11 is connected to the switch circuit 52. The power amplifier (PA) 11 can amplify a radio frequency (RF) signal by using power supplied from a power supply.

A part or the entirety of the power amplifier (PA) 11 may be implemented by a semiconductor component. For example, silicon germanium (SiGe) or gallium arsenide (GaAs) may be used as the semiconductor material of the semiconductor component. In this case, some or all of the amplification transistors constituting the power amplifier (PA) 11 may be implemented by heterojunction bipolar transistors (HBT). Also, gallium nitride (GaN) or silicon carbide (SiC) may be used as the semiconductor material of the semiconductor component. In this case, some or all of the amplification transistors constituting the power amplifier (PA) 11 may be implemented by high electron mobility transistors (HEMT) or metal-semiconductor field effect transistors (MESFET). Also, silicon single crystal (Si) may be used as the semiconductor material of the semiconductor component. In this case, some or all of the amplification transistors constituting the power amplifier (PA) 11 may be implemented by complementary metal oxide semiconductors (CMOS) or may be manufactured by a silicon-on-insulator (SOI) process. The power amplifier (PA) 11 may be constituted by multiple semiconductor components.

The low-noise amplifier 21 is an example of a first low-noise amplifier and is connected between the inductor 41 and the radio frequency output terminal 121. Specifically, the input end of the low-noise amplifier 21 is connected to the inductor 41, and the output end of the low-noise amplifier 21 is connected to the radio frequency output terminal 121. The low-noise amplifier 21 is included in the semiconductor component 72.

The low-noise amplifier 22 is an example of a second low-noise amplifier and is connected between the inductor 42 and the radio frequency output terminal 122. Specifically, the input end of the low-noise amplifier 22 is connected to the inductor 42, and the output end of the low-noise amplifier 22 is connected to the radio frequency output terminal 122. The low-noise amplifier 22 is included in the semiconductor component 72.

The low-noise amplifiers 21 and 22 are controlled based on the digital control signals D1 and D2. Specifically, the low-noise amplifiers 21 and 22 can be turned on and off individually. For example, the low-noise amplifiers 21 and 22 may be turned on and off by supplying and removing a power supply voltage. Also, for example, the low-noise amplifiers 21 and 22 may be turned on and off by supplying and removing a bias voltage.

The filter 31 is an example of a first filter and is a band pass filter with a pass band including the TDD band A. The filter 31 can pass signals (A-TRx) in the TDD band A and can attenuate signals outside of the TDD band A. The filter 31 is connected between the switch circuits 51 and 52. Specifically, a first end of the filter 31 is connected to a selection terminal 511 of the switch circuit 51, and a second end of the filter 31 is connected to a common terminal 521 of the switch circuit 52.

The filter 32 is an example of a second filter and is a band pass filter with a pass band including a reception band of an FDD band B. The filter 32 can pass signals (B-Rx) in the reception band of the FDD band B and can attenuate signals outside of the reception band of the FDD band B. The filter 32 is connected between the switch circuits 51 and 53. Specifically, a first end of the filter 32 is connected to a selection terminal 512 of the switch circuit 51, and a second end of the filter 32 is connected to a selection terminal 534 of the switch circuit 53.

The filter 33 is an example of a third filter and is a band pass filter with a pass band including a transmission band of the FDD band B. The filter 33 can pass signals (B-Tx) in the transmission band of the FDD band B and can attenuate signals outside of the transmission band of the FDD band B. The filter 33 is connected between the switch circuits 51 and 52. Specifically, a first end of the filter 33 is connected to the selection terminal 512 of the switch circuit 51, and a second end of the filter 33 is connected to a common terminal 522 of the switch circuit 52. The filter 33 may not be included in the radio frequency module 1.

As a non-limiting example, each of the filters 31 to 33 may be implemented by a surface acoustic wave (SAW) filter, a bulk acoustic wave (BAW) filter, an LC filter, a dielectric filter, or any combination of these filters.

The inductor 41 is an example of a first inductor and is connected between the switch circuit 53 and the low-noise amplifier 21. Specifically, a first end of the inductor 41 is connected to a common terminal 531 of the switch circuit 53, and a second end of the inductor 41 is connected to the input end of the low-noise amplifier 21. The inductor 41 can achieve impedance matching between the switch circuit 53 and the low-noise amplifier 21. The inductor 41 may not be included in the radio frequency module 1.

The inductor 42 is an example of a second inductor and is connected between the switch circuit 53 and the low-noise amplifier 22. Specifically, a first end of the inductor 42 is connected to a common terminal 532 of the switch circuit 53, and a second end of the inductor 42 is connected to the input end of the low-noise amplifier 22. The inductor 42 can achieve impedance matching between the switch circuit 53 and the low-noise amplifier 22. The inductor 42 may not be included in the radio frequency module 1.

The switch circuit 51 is an example of a first switch circuit and is connected between the antenna connection terminal 100 and the filters 31-33. Specifically, the switch circuit 51 includes a common terminal 510 and selection terminals 511 and 512. The common terminal 510 is an example of a first common terminal and is connected to the antenna connection terminal 100. The selection terminal 511 is an example of a first selection terminal and is connected to the filter 31. The selection terminal 512 is an example of a second selection terminal and is connected to the filters 32 and 33. The switch circuit 51 is included in a semiconductor component 71b and is implemented by, for example, a multi-connection switch circuit.

With this configuration, the switch circuit 51 can connect the common terminal 510 to the selection terminals 511 and 512 based on the digital control signal D1 from the RFIC 3. In other words, the switch circuit 51 can connect and disconnect the antenna connection terminal 100 to and from the filter 31 and can connect and disconnect the antenna connection terminal 100 to and from the filters 32 and 33.

The switch circuit 52 is an example of a second switch circuit and is connected between the filter 31 and each of the power amplifier (PA) 11 and the low-noise amplifier 21 and is also connected between the filter 33 and the power amplifier (PA) 11. Specifically, the switch circuit 52 includes common terminals 521 and 522 and selection terminals 523 and 524. The common terminal 521 is an example of a second common terminal and is connected to the filter 31. The common terminal 522 is an example of a fifth common terminal and is connected to the filter 33. When the filter 33 is not included in the radio frequency module 1, the common terminal 522 may not be included in the switch circuit 52. The selection terminal 523 is an example of a third selection terminal and is connected to the power amplifier (PA) 11. The selection terminal 524 is an example of a fourth selection terminal and is connected to the low-noise amplifier 21 via the switch circuit 53 and the inductor 41. The switch circuit 52 is included in a semiconductor component 71c and is implemented by, for example, a multi-connection switch circuit.

With this configuration, the switch circuit 52 can selectively connect the common terminal 521 to the selection terminals 523 and 524 and selectively connect the selection terminal 523 to the common terminals 521 and 522 based on, for example, the digital control signal D1 from the RFIC 3. In other words, the switch circuit 52 can connect the filter 31 either to the output end of the power amplifier (PA) 11 or to the input end of the low-noise amplifier 21 via the switch circuit 53, and can also connect the output end of the power amplifier (PA) 11 either to the filter 31 or to the filter 33.

The switch circuit 53 is an example of a third switch circuit and is connected between the low-noise amplifiers 21 and 22 and the filters 31 and 32. Specifically, the switch circuit 53 includes common terminals 531 and 532 and selection terminals 533 and 534. The common terminal 531 is an example of a third common terminal and is connected to the input end of the low-noise amplifier 21 via the inductor 41. The common terminal 532 is an example of a fourth common terminal and is connected to the input end of the low-noise amplifier 22 via the inductor 42. The selection terminal 533 is an example of a fifth selection terminal and is connected to the fourth selection terminal 524 of the second switch circuit 52. The selection terminal 534 is an example of a sixth selection terminal and is connected to the filter 32. The switch circuit 53 is included in the semiconductor component 72 and is implemented by two single-pole single-throw (SPST) switches. The switch circuit 53 may not be included in the semiconductor component 72 or the radio frequency module 1.

With this configuration, the switch circuit 53 can connect and disconnect the common terminal 531 to and from the selection terminal 533 and connect and disconnect the common terminal 532 to and from the selection terminal 534 based on, for example, the digital control signals D1 and D2 from the RFIC 3. In other words, the switch circuit 53 can connect and disconnect the input end of the low-noise amplifier 21 to and from the filter 31 via the switch circuit 52 and can connect and disconnect the input end of the low-noise amplifier 22 to and from the filter 32.

The PA control circuit 61 can control the power amplifier (PA) 11. Specifically, the PA control circuit 61 supplies a control signal for controlling the power amplifier (PA) 11 to the power amplifier (PA) 11 based on the digital control signal D1 supplied from the RFIC 3 via the digital control terminal 131. This makes it possible to control, for example, a bias current supplied to the power amplifier (PA) 11. The PA control circuit 61 is included in a semiconductor component 71a.

The semiconductor component 71a is an example of a first semiconductor component and includes the PA control circuit 61. The semiconductor component 71a is connected to the digital control terminal 131.

The semiconductor component 71b is an example of a first semiconductor component and includes the switch circuit 51. The semiconductor component 71b is connected to the digital control terminal 131.

The semiconductor component 71c is an example of a first semiconductor component and includes the switch circuit 52. The semiconductor component 71c is connected to the digital control terminal 131.

The semiconductor component 72 is an example of a second semiconductor component and includes the low-noise amplifiers 21 and 22 and the switch circuit 53. The semiconductor component 72 is connected to the digital control terminal 132. Also, the semiconductor component 72 is connected to the digital control terminal 131 via the semiconductor component 71a.

In the present embodiment, the semiconductor component 72 is connected to the digital control terminal 131 via the semiconductor component 71a. However, the semiconductor component 72 may be connected to the digital control terminal 131 via another semiconductor component. For example, the semiconductor component 72 may be connected to the digital control terminal 131 via the semiconductor component 71b and/or the semiconductor component 71c instead of, or in addition to, the semiconductor component 71a.

Examples of semiconductor materials for the semiconductor components 71a, 71b, 71c, and 72 include silicon single crystal (Si), gallium nitride (GaN), and silicon carbide (SiC). In this case, some or all of the low-noise amplifiers 21 and 22, the PA control circuit 61, and the switch circuits 51 to 53 may be implemented by FETs. Alternatively, bipolar transistors may be used instead of FETs.

Circuit components of the radio frequency module 1 described above are placed on or in a module laminate. As a non-limiting example, the module laminate may be implemented by a low temperature co-fired ceramics (LTCC) substrate or a high temperature co-fired ceramics (HTCC) substrate with a multilayer structure formed of multiple dielectric layers, a component-embedded board, a substrate including a redistribution layer (RDL), or a printed circuit board.

### 1.3. Frequency Bands

The TDD band A and the FDD band B supported by the radio frequency module 1 are described.

The TDD band A and the FDD band B are frequency bands for a communication system that is constructed using a radio access technology (RAT). The TDD band A and the FDD band B are predefined by, for example, standardizing bodies (e.g., 3GPP and IEEE). Examples of communication systems include a 5th Generation New Radio (5G NR) system, a 4th Generation Long Term Evolution (4G LTE) system, and a wireless Local area network (WLAN) system.

For example, Band 41 for 4G LTE or n41 for 5G NR may be used as the TDD band A. Also, for example, Band 66 for 4G LTE or n66 for 5G NR may be used as the FDD band B. However, the combination of the TDD band A and the FDD band B is not limited to the above example. As another example, a combination of Band 41 or n41 and Band 1 or n1, a combination of Band 41 or n41 and Band 3 or n3, a combination of Band 41 or n41 and Band 25 or n25, or a combination of Band 41 or n41 and Band 32 or n32 may be used as the combination of the TDD band A and the FDD band B. As still another example, a combination of Band 40 or n40 and Band 1 or n1, a combination of Band 40 or n40 and Band 3 or n3, a combination of Band 40 or n40 and Band 7 or n7, or a combination of Band 40 or n40 and Band 32 or n32 may be used as the combination of the TDD band A and the FDD band B.

### 1.4. Communication Modes

Next, communication modes of the radio frequency module 1 according to the present embodiment are described.

### 1.4.1. First Mode (First Connection State)

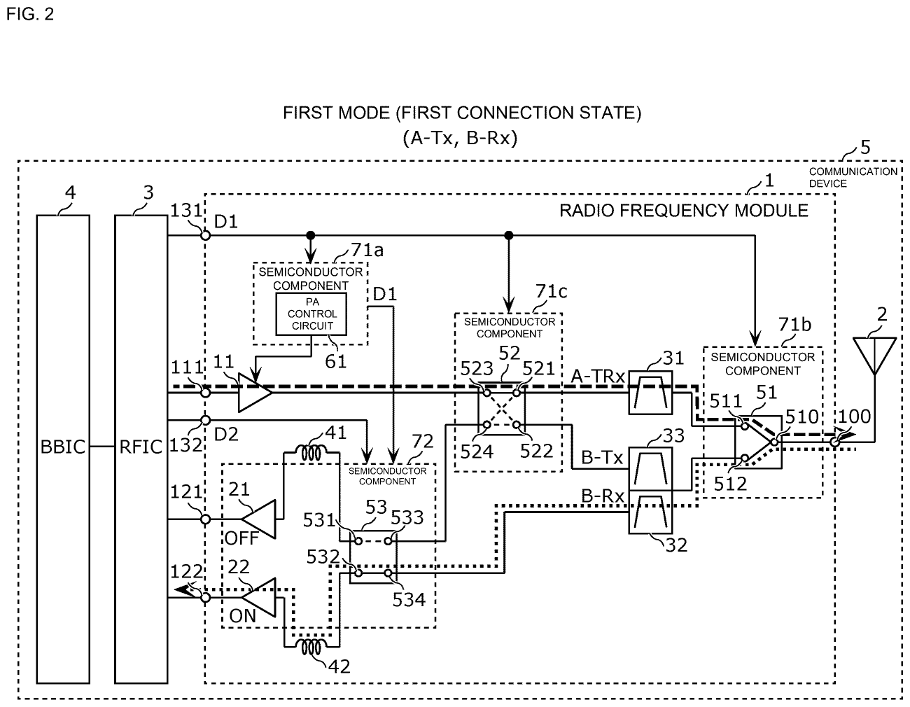

First, a first connection state of a first mode included in the communication modes of the radio frequency module 1 is described with reference to FIG. 2. FIG. 2 is a diagram illustrating the first connection state of the first mode of the radio frequency module 1 according to the present embodiment. In FIG. 2, dashed (dotted) arrows represent signal paths.

The first mode is a communication mode for transmitting and receiving signals in the TDD band A and for receiving signals in the FDD band B. In the first connection state, it is possible to transmit a signal in the TDD band A and receive a signal in the FDD band B. In the first mode, it is possible to separate a transmission signal and a reception signal in the TDD band A by repeatedly switching, at time intervals, between the first connection state and a second connection state described later.

In the first connection state of the first mode, the switch circuit 51 connects the common terminal 510 to the selection terminals 511 and 512. The switch circuit 52 connects the common terminal 521 to the selection terminal 523 but not to the selection terminal 524. Also, the switch circuit 52 does not connect the common terminal 522 to the selection terminal 523. The switch circuit 53 connects the common terminal 532 to the selection terminal 534 but does not connect the common terminal 531 to the selection terminal 533. The low-noise amplifier 21 is turned off, and the low-noise amplifier 22 is turned on.

In this connection state, a transmission signal in the TDD band A is transmitted from the RFIC 3, via the radio frequency input terminal 111, the power amplifier (PA) 11, the switch circuit 52, the filter 31, the switch circuit 51, and the antenna connection terminal 100, to the antenna 2. A reception signal in the FDD band B is transmitted from the antenna 2, via the antenna connection terminal 100, the switch circuit 51, the filter 32, the switch circuit 53, the inductor 42, the low-noise amplifier 22, and the radio frequency output terminal 122, to the RFIC 3.

Thus, in the first connection state of the first mode, the low-noise amplifier 21 is turned off, and the common terminal 531 of the switch circuit 53 is not connected to the selection terminal 533. Therefore, even if a transmission signal in the TDD band A leaks into the receive path of the TDD band A via the switch circuit 52, the transmission signal can be prevented from leaking into the receive path of the FDD band B due to the coupling between the low-noise amplifiers 21 and 22 and/or the coupling between the inductors 41 and 42. This in turn makes it possible to reduce the degradation of the reception sensitivity in the FDD band B in simultaneous communication using the TDD band A and the FDD band B.

### 1.4.2. First Mode (Second Connection State)

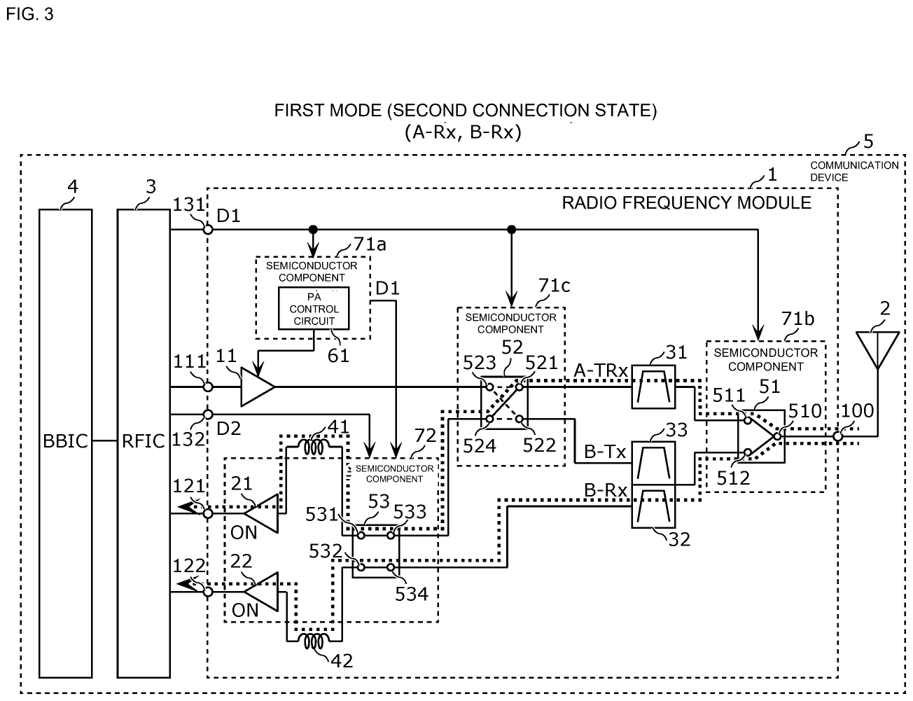

Next, a second connection state of the first mode included in the communication modes of the radio frequency module 1 is described with reference to FIG. 3. FIG. 3 is a diagram illustrating the second connection state of the first mode of the radio frequency module 1 according to the present embodiment. In FIG. 3, dashed (dotted) arrows represent signal paths.

As described above, the first mode is a communication mode for transmitting and receiving signals in the TDD band A and for receiving signals in the FDD band B. In the second connection state, it is possible to receive a signal in the TDD band A and also receive a signal in the FDD band B. In the first mode, it is possible to separate a transmission signal and a reception signal in the TDD band A by repeatedly switching, at time intervals, between the first connection state and the second connection state.

In the second connection state of the first mode, the switch circuit 51 connects the common terminal 510 to the selection terminals 511 and 512. The switch circuit 52 connects the common terminal 521 to the selection terminal 524 but not to the selection terminal 523. Also, the switch circuit 52 does not connect the common terminal 522 to the selection terminal 523. The switch circuit 53 connects the common terminal 531 to the selection terminal 533 and connects the common terminal 532 to the selection terminal 534. The low-noise amplifiers 21 and 22 are both turned on.

In this connection state, a reception signal in the TDD band A is transmitted from the antenna 2, via the antenna connection terminal 100, the switch circuit 51, the filter 31, the switch circuit 52, the switch circuit 53, the inductor 41, the low-noise amplifier 21, and the radio frequency output terminal 121, to the RFIC 3. A reception signal in the FDD band B is transmitted from the antenna 2, via the antenna connection terminal 100, the switch circuit 51, the filter 32, the switch circuit 53, the inductor 42, the low-noise amplifier 22, and the radio frequency output terminal 122, to the RFIC 3.

### 1.4.3. Second Mode

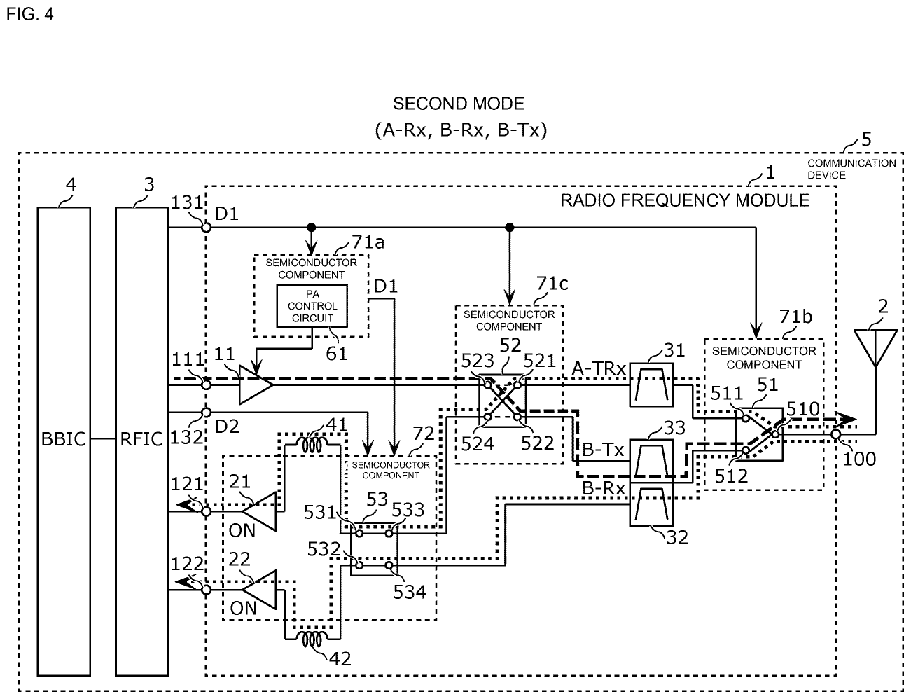

Next, a second mode included in the communication modes of the radio frequency module 1 is described with reference to FIG. 4. FIG. 4 is a diagram illustrating the second mode of the radio frequency module 1 according to the present embodiment. In FIG. 4, dashed (dotted) arrows represent signal paths.

The second mode is a communication mode for receiving signals in the TDD band A and transmitting and receiving signals in the FDD band B. In the second mode, the switch circuit 51 connects the common terminal 510 to the selection terminals 511 and 512. The switch circuit 52 connects the common terminal 521 to the selection terminal 524 but not to the selection terminal 523. Also, the switch circuit 52 connects the common terminal 522 to the selection terminal 523. The switch circuit 53 connects the common terminal 531 to the selection terminal 533 and connects the common terminal 532 to the selection terminal 534. The low-noise amplifiers 21 and 22 are both turned on.

In this connection state, a reception signal in the TDD band A is transmitted from the antenna 2, via the antenna connection terminal 100, the switch circuit 51, the filter 31, the switch circuit 52, the switch circuit 53, the inductor 41, the low-noise amplifier 21, and the radio frequency output terminal 121, to the RFIC 3. A transmission signal in the FDD band B is transmitted from the RFIC 3, via the radio frequency input terminal 111, the power amplifier (PA) 11, the switch circuit 52, the filter 33, the switch circuit 51, and the antenna connection terminal 100, to the antenna 2. A reception signal in the FDD band B is transmitted from the antenna 2, via the antenna connection terminal 100, the switch circuit 51, the filter 32, the switch circuit 53, the inductor 42, the low-noise amplifier 22, and the radio frequency output terminal 122, to the RFIC 3.

Although the first mode and the second mode of the radio frequency module 1 are described above with reference to FIGS. 2 to 4, the communication modes of the radio frequency module 1 are not limited to the first mode and the second mode. For example, the communication modes of the radio frequency module 1 do not necessarily include the second mode. As another example, the communication modes of the radio frequency module 1 may include a mode in which signals in the TDD band A are transmitted and/or received, but signals in the FDD band B are neither transmitted nor received; and a mode in which signals in the FDD band B are transmitted and/or received, but signals in the TDD band A are neither transmitted nor received.

### 1.5. Summary

As described above, the radio frequency module 1 according to the present embodiment includes the digital control terminals 131 and 132; the antenna connection terminal 100; the semiconductor component 71a connected to the digital control terminal 131; the semiconductor component 72 connected to the digital control terminal 132 and including the low-noise amplifiers 21 and 22; the power amplifier (PA) 11; the PA control circuit 61; the filter 31 with a pass band including the TDD band A; the filter 32 that is connected to the low-noise amplifier 22 and has a pass band including a reception band of the FDD band B usable for simultaneous communication with the TDD band A; the switch circuit 51 including the common terminal 510 connected to the antenna connection terminal 100, the selection terminal 511 connected to the filter 31, and the selection terminal 512 connected to the filter 32; and the switch circuit 52 including the common terminal 521 connected to the filter 31, the selection terminal 523 connected to the power amplifier (PA) 11, and the selection terminal 524 connected to the low-noise amplifier 21. The semiconductor component 72 is also connected to the digital control terminal 131 via the semiconductor component 71a.

With this configuration, the semiconductor component 72 is connected to the digital control terminal 131 in addition to the digital control terminal 132. This makes it possible to control the semiconductor component 72 including the low-noise amplifiers 21 and 22 based on the digital control signal D1 supplied from the RFIC 3 via the digital control terminal 131 in addition to the digital control signal D2 supplied from the RFIC 3 via the digital control terminal 132. In the simultaneous communication using the TDD band A and the FDD band B, the above configuration makes it possible to control the semiconductor component 72 in response to the switching between transmission and reception in the TDD band A. This in turn makes it possible to reduce the leakage of transmission signals in the TDD band A into the low-noise amplifiers 21 and 22 and thereby makes it possible to reduce the degradation of the reception sensitivity in the FDD band B in the simultaneous communication using the TDD band A and the FDD band B.

Also, for example, in the radio frequency module 1 according to the present embodiment, the semiconductor component 71a may include the PA control circuit 61.

This makes it possible to supply the digital control signal D1, which is supplied from the RFIC 3 to the PA control circuit 61, to the semiconductor component 72 and thereby makes it possible to reduce the leakage of transmission signals in the TDD band A into the low-noise amplifiers 21 and 22.

Also, for example, in the radio frequency module 1 according to the present embodiment, the semiconductor component 72 may be connected to the digital control terminal 131 via the semiconductor component 71b instead of, or in addition to, the semiconductor component 71a, and the semiconductor component 71b may include the switch circuit 51.

This configuration makes it possible to supply the digital control signal D1 for controlling the switch circuit 51 to the semiconductor component 72 and thereby makes it possible to reduce the leakage of transmission signals in the TDD band A into the low-noise amplifiers 21 and 22.

Also, for example, in the radio frequency module 1 according to the present embodiment, the semiconductor component 72 may be connected to the digital control terminal 131 via the semiconductor component 71c instead of, or in addition to, the semiconductor component 71a, and the semiconductor component 71c may include the switch circuit 52.

This makes it possible to supply the digital control signal D1 for controlling the switch circuit 52 to the semiconductor component 72 and thereby makes it possible to reduce the leakage of transmission signals in the TDD band A into the low-noise amplifiers 21 and 22.

Also, for example, in the radio frequency module 1 according to the present embodiment, the digital control terminal 131 may be an external connection terminal that receives the digital control signal D1 including a signal for controlling the power amplifier (PA) 11, and the digital control terminal 132 may be an external connection terminal that receives the digital control signal D2 including signals for controlling the low-noise amplifiers 21 and 22.

This configuration makes it possible to control the semiconductor component 72 including the low-noise amplifiers 21 and 22 based on the digital control signal D1, which is supplied from the RFIC 3 via the digital control terminal 131 and includes a signal for controlling the power amplifier (PA) 11, in addition to the digital control signal D2 that is supplied from the RFIC 3 via the digital control terminal 132 and includes signals for controlling the low-noise amplifiers 21 and 22.

Also, for example, in the radio frequency module 1 according to the present embodiment, in the first connection state in which a signal in the TDD band A is transmitted and a signal in the reception band of the FDD band B is received, (i) the switch circuit 51 may connect the common terminal 510 to the selection terminals 511 and 512, (ii) the switch circuit 52 may connect the common terminal 521 to the selection terminal 523 but not to the selection terminal 524, and (iii) the low-noise amplifier 21 may be turned off, and the low-noise amplifier 22 may be turned on; and in the second connection state in which a signal in the TDD band A is received and a signal in the reception band of the FDD band B is received, (iv) the switch circuit 51 may connect the common terminal 510 to the selection terminals 511 and 512, (v) the switch circuit 52 may connect the common terminal 521 to the selection terminal 524 but not to the selection terminal 523, and (vi) the low-noise amplifiers 21 and 22 may be turned on.

With this configuration, in the first connection state, the low-noise amplifier 21 is turned off. Therefore, even if a transmission signal in the TDD band A leaks into the receive path of the TDD band A via the switch circuit 52, the transmission signal can be prevented from leaking into the receive path of the FDD band B due to the coupling between the low-noise amplifiers 21 and 22. This in turn makes it possible to reduce the degradation of the reception sensitivity in the FDD band B in the simultaneous communication using the TDD band A and the FDD band B.

Also, for example, in the radio frequency module 1 according to the present embodiment, the semiconductor component 72 may further include the switch circuit 53 that includes the common terminal 531 connected to the low-noise amplifier 21, the common terminal 532 connected to the low-noise amplifier 22, the selection terminal 533 connected to the selection terminal 524, and the selection terminal 534 connected to the filter 32.

This configuration makes it possible to further reduce the leakage of a transmission signal in the TDD band A into the receive path of the TDD band A and the receive path of the FDD band B.

For example, the radio frequency module 1 according to the present embodiment may further include the inductor 41 connected between the common terminal 531 and the low-noise amplifier 21 and the inductor 42 connected between the common terminal 532 and the low-noise amplifier 22.

This makes it possible to reduce the signal loss resulting from the impedance mismatching between the low-noise amplifiers 21 and 22 and the switch circuit 53.

Also, for example, in the radio frequency module 1 according to the present embodiment, in the first connection state in which a signal in the TDD band A is transmitted and a signal in the reception band of the FDD band B is received, (i) the switch circuit 51 may connect the common terminal 510 to the selection terminals 511 and 512, (ii) the switch circuit 52 may connect the common terminal 521 to the selection terminal 523 but not to the selection terminal 524, and (iii) the switch circuit 53 does not need to connect the common terminal 531 to the selection terminal 533 and may connect the common terminal 532 to the selection terminal 534; and in the second connection state in which a signal in the TDD band A is received and a signal in the reception band of the FDD band B is received, (iv) the switch circuit 51 may connect the common terminal 510 to the selection terminals 511 and 512, (v) the switch circuit 52 may connect the common terminal 521 to the selection terminal 524 but not to the selection terminal 523, and (vi) the switch circuit 53 may connect the common terminal 531 to the selection terminal 533 and connect the common terminal 532 to the selection terminal 534.

With this configuration, in the first connection state, the switch circuit 53 does not connect the common terminal 531 to the selection terminal 533. Therefore, even if a transmission signal in the TDD band A leaks to the receive path of the TDD band A via the switch circuit 52, the transmission signal can be prevented from leaking into the receive path of the FDD band B due to the coupling between the low-noise amplifiers 21 and 22 and/or the coupling between the inductors 41 and 42. This in turn makes it possible to reduce the degradation of the reception sensitivity in the FDD band B in the simultaneous communication using the TDD band A and the FDD band B.

Also, for example, the radio frequency module 1 according to the present embodiment may further include the filter 33 that is connected to the selection terminal 512 and has a pass band including the transmission band of the FDD band B, and the switch circuit 52 may further include the common terminal 522 connected to the filter 33.

This makes it possible to support the transmission of signals in the FDD band B.

### Second Embodiment

Next, a second embodiment is described. A radio frequency module 1A according to the present embodiment differs primarily from the radio frequency module 1 according to the first embodiment in that the radio frequency module 1A includes separate filters for the transmission and reception of signals in the TDD band A. Below, differences in the second embodiment from the first embodiment are mainly described with reference to the drawings.

The circuit configuration of a communication device 5A according to the present embodiment is substantially the same as that of the communication device 5 according to the first embodiment, except that the communication device 5A includes the radio frequency module 1A instead of the radio frequency module 1. Therefore, descriptions of the circuit configuration of the communication device 5A not repeated.

### 2.1. Circuit Configuration of Radio Frequency Module 1A

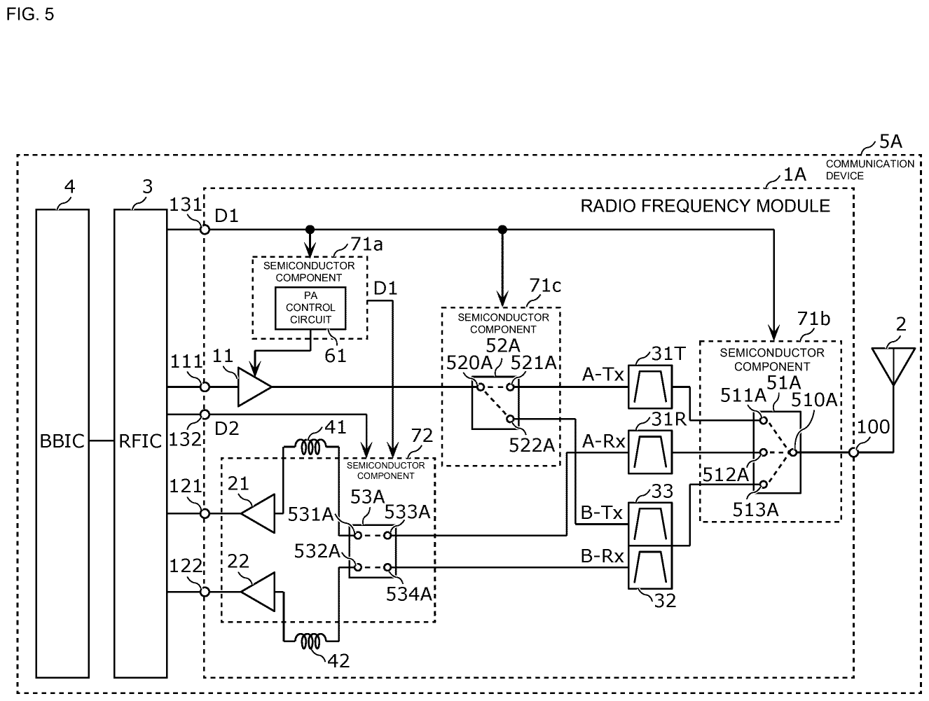

A circuit configuration of the radio frequency module 1A according to the present embodiment is described with reference to FIG. 5. FIG. 5 is a circuit diagram of the communication device 5A according to the present embodiment. In FIG. 5, dotted lines in each switch circuit represent paths between terminals that are selectively connectable and disconnectable.

Here, FIG. 5 illustrates an exemplary circuit configuration, and the radio frequency module 1A may be implemented by using any of various types of circuit implementation and circuit technologies. Therefore, the descriptions of the radio frequency module 1A provided below are not restrictive.

The radio frequency module 1A includes a power amplifier (PA) 11, low-noise amplifiers 21 and 22, filters 31T, 31R, 32, and 33, inductors 41 and 42, switch circuits 51A, 52A, and 53A, an antenna connection terminal 100, a radio frequency input terminal 111, radio frequency output terminals 121 and 122, and digital control terminals 131 and 132.

The filter 31T is an example of a first filter and is a band pass filter with a pass band including the TDD band A. The filter 31T can pass signals in the TDD band A and can attenuate signals outside of the TDD band A. The filter 31T is used for transmission signals (A-Tx) in the TDD band A. The filter 31T is connected between the switch circuits 51A and 52A. Specifically, a first end of the filter 31T is connected to a selection terminal 511A of the switch circuit 51A, and a second end of the filter 31T is connected to a selection terminal 521A of the switch circuit 52A.

The filter 31R is an example of a second filter and is a band pass filter with a pass band including the TDD band A. The filter 31R can pass signals in the TDD band A and can attenuate signals outside of the TDD band A. The filter 31R is used for reception signals (A-Rx) in the TDD band A. The filter 31R is connected between the switch circuits 51A and 53A. Specifically, a first end of the filter 31R is connected to a selection terminal 512A of the switch circuit 51A, and a second end of the filter 31R is connected to a selection terminal 533A of the switch circuit 53A.

The filter 32 is an example of a third filter and is a band pass filter with a pass band including the reception band of the FDD band B. The filter 32 can pass signals (B-Rx) in the reception band of the FDD band B and can attenuate signals outside of the reception band of the FDD band B. The filter 32 is connected between the switch circuits 51A and 53A. Specifically, a first end of the filter 32 is connected to a selection terminal 513A of the switch circuit 51A, and a second end of the filter 32 is connected to a selection terminal 534A of the switch circuit 53A.

The filter 33 is an example of a fourth filter and is a band pass filter with a pass band including the transmission band of the FDD band B. The filter 33 can pass signals (B-Tx) in the transmission band of the FDD band B and can attenuate signals outside of the transmission band of the FDD band B. The filter 33 is connected between the switch circuits 51A and 52A. Specifically, a first end of the filter 33 is connected to the selection terminal 513A of the switch circuit 51A, and a second end of the filter 33 is connected to a selection terminal 522A of the switch circuit 52A. The filter 33 may not be included in the radio frequency module 1A.

The switch circuit 51A is an example of a first switch circuit and is connected between the antenna connection terminal 100 and the filters 31T, 31R, 32, and 33. Specifically, the switch circuit 51A includes the common terminal 510A and the selection terminals 511A, 512A, and 513A. The common terminal 510A is an example of a first common terminal and is connected to the antenna connection terminal 100. The selection terminal 511A is an example of a first selection terminal and is connected to the filter 31T. The selection terminal 512A is an example of a second selection terminal and is connected to the filter 31R. The selection terminal 513A is an example of a third selection terminal and is connected to the filters 32 and 33. The switch circuit 51A is included in the semiconductor component 71b and is implemented by, for example, a multi-connection switch circuit.

With this configuration, the switch circuit 51A can selectively connect the common terminal 510A to the selection terminals 511A and 512A and can connect and disconnect the common terminal 510A to and from the selection terminal 513A based on, for example, the digital control signal D1 from the RFIC 3. That is, the switch circuit 51A can connect the antenna connection terminal 100 to either the filter 31T or the filter 31R and connect the antenna connection terminal 100 to either the filter 32 or the filter 33.

The switch circuit 52A is an example of a second switch circuit and is connected between the power amplifier (PA) 11 and the filters 31T and 33. Specifically, the switch circuit 52A includes a common terminal 520A and selection terminals 521A and 522A. The common terminal 520A is an example of a second common terminal and is connected to the output end of the power amplifier (PA) 11. The selection terminal 521A is an example of a fourth selection terminal and is connected to the filter 31T. The selection terminal 522A is an example of a fifth selection terminal and is connected to the filter 33. The switch circuit 52A is included in the semiconductor component 71c and is implemented by, for example, a single-pole double-throw (SPDT) switch. When the filter 33 is not in the radio frequency module 1A, the switch circuit 52A may not include the selection terminal 522A or even in the radio frequency module 1A.

With this configuration, the switch circuit 52A can selectively connect the common terminal 520A to the selection terminals 521A and 522A based on, for example, the digital control signal D1 from the RFIC 3. That is, the switch circuit 52A can connect the output end of the power amplifier (PA) 11 to either the filter 31T or the filter 33.

The switch circuit 53A is an example of a third switch circuit and is connected between the low-noise amplifiers 21 and 22 and the filters 31R and 32. Specifically, the switch circuit 53A includes common terminals 531A and 532A and selection terminals 533A and 534A. The common terminal 531A is an example of a third common terminal and is connected to the input end of the low-noise amplifier 21 via the inductor 41. The common terminal 532A is an example of a fourth common terminal and is connected to the input end of the low-noise amplifier 22 via the inductor 42. The selection terminal 533A is an example of a sixth selection terminal and is connected to the filter 31R. The selection terminal 534A is an example of a seventh selection terminal and is connected to the filter 32. The switch circuit 53A is included in the semiconductor component 72 and is implemented by two SPST switches. The switch circuit 53A may not be included in the semiconductor component 72 or even in the radio frequency module 1A.

With this configuration, the switch circuit 53A can connect and disconnect the common terminal 531A to and from the selection terminal 533A and connect and disconnect the common terminal 532A to and from the selection terminal 534A based on, for example, the digital control signals D1 and D2 from the RFIC 3. That is, the switch circuit 53A can connect and disconnect the input end of the low-noise amplifier 21 to and from the filter 31R and connect and disconnect the input end of the low-noise amplifier 22 to and from the filter 32.

### 2.2. Communication Modes

Next, communication modes of the radio frequency module 1A according to the present embodiment are described.

### 2.2.1 First Mode (First Connection State)

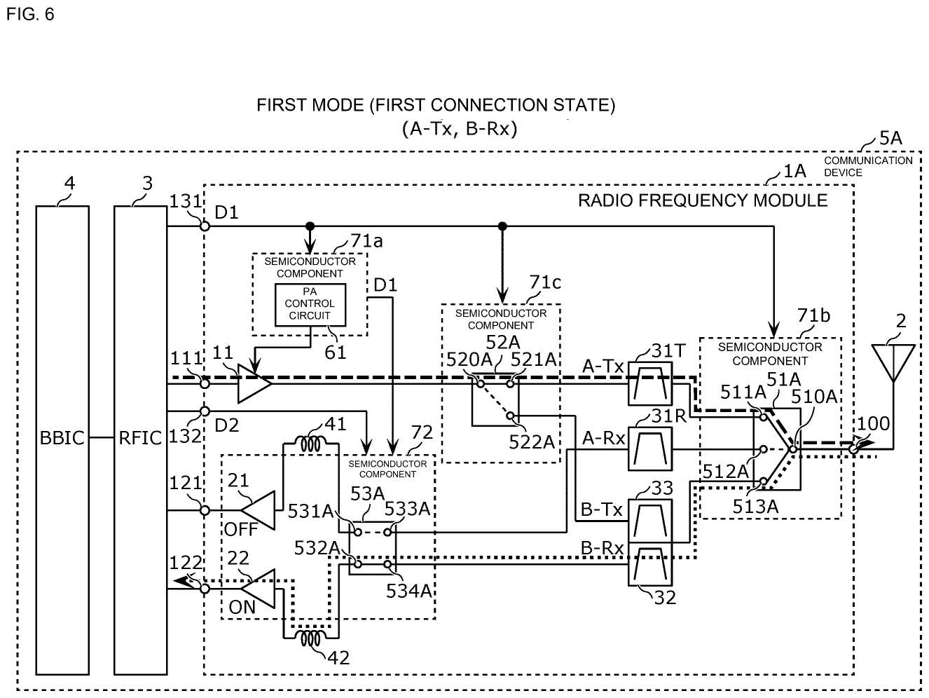

First, a first connection state of a first mode included in the communication modes of the radio frequency module 1A is described with reference to FIG. 6. FIG. 6 is a diagram illustrating the first connection state of the first mode of the radio frequency module 1A according to the present embodiment. In FIG. 6, dashed (dotted) arrows represent signal paths.

In the first connection state of the first mode, the switch circuit 51A connects the common terminal 510A to the selection terminals 511A and 513A but not to the selection terminal 512A. The switch circuit 52A connects the common terminal 520A to the selection terminal 521A but not to the selection terminal 522A. The switch circuit 53A connects the common terminal 532A to the selection terminal 534A but does not connect the common terminal 531A to the selection terminal 533A. The low-noise amplifier 21 is turned off, and the low-noise amplifier 22 is turned on.

In this connection state, a transmission signal in the TDD band A is transmitted from the RFIC 3, via the radio frequency input terminal 111, the power amplifier (PA) 11, the switch circuit 52A, the filter 31T, the switch circuit 51A, and the antenna connection terminal 100, to the antenna 2. A reception signal in the FDD band B is transmitted from the antenna 2, via the antenna connection terminal 100, the switch circuit 51A, the filter 32, the switch circuit 53A, the inductor 42, the low-noise amplifier 22, and the radio frequency output terminal 122, to the RFIC 3.

Thus, in the first connection state of the first mode, the low-noise amplifier 21 is turned off, and the common terminal 531A of the switch circuit 53A is not connected to the selection terminal 533A. Therefore, even if a transmission signal in the TDD band A leaks into the receive path of the TDD band A via the switch circuit 51A, the transmission signal can be prevented from leaking into the receive path of the FDD band B due to the coupling between the inductors 41 and 42. This in turn makes it possible to reduce the degradation of the reception sensitivity in the FDD band B in simultaneous communication using the TDD band A and the FDD band B.

### 2.2.2. First Mode (Second Connection State)

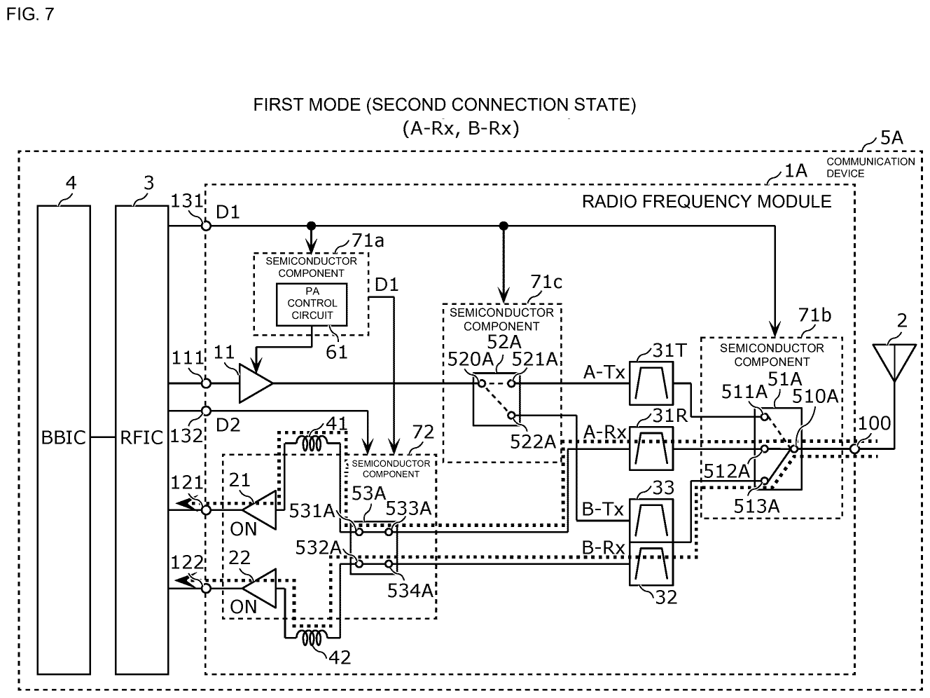

Next, a second connection state of the first mode included in the communication modes of the radio frequency module 1A is described with reference to FIG. 7. FIG. 7 is a diagram illustrating the second connection state of the first mode of the radio frequency module 1A according to the present embodiment. In FIG. 7, dashed (dotted) arrows represent signal paths.

In the second connection state of the first mode, the switch circuit 51A connects the common terminal 510A to the selection terminals 512A and 513A and not to the selection terminal 511A. The switch circuit 52A does not connect the common terminal 520A to the selection terminals 521A and 522A. The switch circuit 53A connects the common terminal 531A to the selection terminal 533A and connects the common terminal 532A to the selection terminal 534A. The low-noise amplifiers 21 and 22 are both turned on.

In this connection state, a reception signal in the TDD band A is transmitted from the antenna 2, via the antenna connection terminal 100, the switch circuit 51A, the filter 31R, the switch circuit 53A, the inductor 41, the low-noise amplifier 21, and the radio frequency output terminal 121, to the RFIC 3. A reception signal in the FDD band B is transmitted from the antenna 2, via the antenna connection terminal 100, the switch circuit 51A, the filter 32, the switch circuit 53A, the inductor 42, the low-noise amplifier 22, and the radio frequency output terminal 122, to the RFIC 3.

### 2.2.3. Second Mode

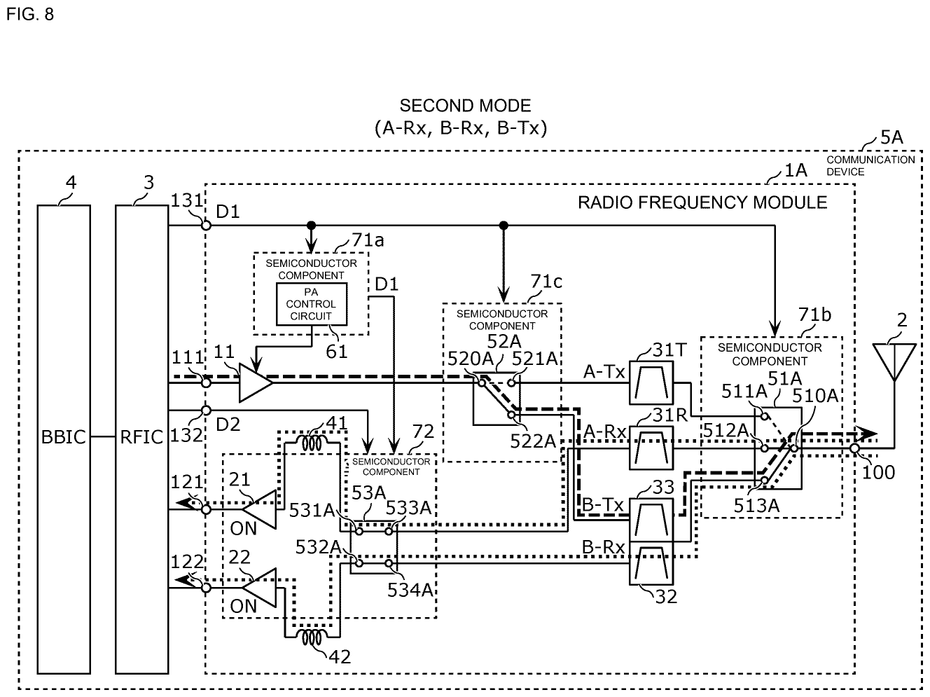

Next, a second mode included in the communication modes of the radio frequency module 1A is described with reference to FIG. 8. FIG. 8 is a diagram illustrating the second mode of the radio frequency module 1A according to the present embodiment. In FIG. 8, dashed (dotted) arrows represent signal paths.

In the second mode, the switch circuit 51A connects the common terminal 510A to the selection terminals 512A and 513A but not to the selection terminal 511A. The switch circuit 52A connects the common terminal 520A to the selection terminal 522A but not to the selection terminal 521A. The switch circuit 53A connects the common terminal 531A to the selection terminal 533A and connects the common terminal 532A to the selection terminal 534A. The low-noise amplifiers 21 and 22 are both turned on.

In this connection state, a reception signal in the TDD band A is transmitted from the antenna 2, via the antenna connection terminal 100, the switch circuit 51A, the filter 31R, the switch circuit 53A, the inductor 41, the low-noise amplifier 21, and the radio frequency output terminal 121, to the RFIC 3. A transmission signal in the FDD band B is transmitted from the RFIC 3, via the radio frequency input terminal 111, the power amplifier (PA) 11, the switch circuit 52A, the filter 33, the switch circuit 51A, and the antenna connection terminal 100, to the antenna 2. A reception signal in the FDD band B is transmitted from the antenna 2, via the antenna connection terminal 100, the switch circuit 51A, the filter 32, the switch circuit 53A, the inductor 42, the low-noise amplifier 22, and the radio frequency output terminal 122, to the RFIC 3.

Although the first mode and the second mode of the radio frequency module 1A are described above with reference to FIGS. 6 to 8, the communication modes of the radio frequency module 1A are not limited to the first mode and the second mode. For example, the communication modes of the radio frequency module 1A may not include the second mode. As another example, the communication modes of the radio frequency module 1A may include a mode in which signals in the TDD band A are transmitted and/or received, but signals in the FDD band B are neither transmitted nor received; and a mode in which signals in the FDD band B are transmitted and/or received, but signals in the TDD band A are neither transmitted nor received.

### 2.3. Summary

As described above, the radio frequency module 1A according to the present embodiment includes the digital control terminals 131 and 132; the antenna connection terminal 100; the semiconductor component 71a connected to the digital control terminal 131; the semiconductor component 72 that is connected to the digital control terminal 132 and includes the low-noise amplifiers 21 and 22; the power amplifier (PA) 11; the PA control circuit 61; the filter 31T that is connected to the power amplifier (PA) 11 and has a pass band including the TDD band A; the filter 31R that is connected to the low-noise amplifier 21 and has a pass band including the TDD band A; the filter 32 that is connected to the low-noise amplifier 22 and has a pass band including the reception band of the FDD band B usable for simultaneous communication with the TDD band A; and the switch circuit 51A including the common terminal 510A connected to the antenna connection terminal 100, the selection terminal 511A connected to the filter 31T, the selection terminal 512A connected to the filter 31R, and the selection terminal 513A connected to the filter 32. The semiconductor component 72 is also connected to the digital control terminal 131 via the semiconductor component 71a.

With this configuration, the semiconductor component 72 is connected to the digital control terminal 131 in addition to the digital control terminal 132. This makes it possible to control the semiconductor component 72 including the low-noise amplifiers 21 and 22 based on the digital control signal D1 supplied from the RFIC 3 via the digital control terminal 131 in addition to the digital control signal D2 supplied from the RFIC 3 via the digital control terminal 132. In the simultaneous communication using the TDD band A and the FDD band B, the above configuration makes it possible to control the semiconductor component 72 in response to the switching between transmission and reception in the TDD band A. This in turn makes it possible to reduce the leakage of a transmission signal in the TDD band A into the low-noise amplifiers 21 and 22 and thereby makes it possible to reduce the degradation of the reception sensitivity in the FDD band B in the simultaneous communication using the TDD band A and the FDD band B.

For example, in the radio frequency module 1A according to the present embodiment, the semiconductor component 71a may include the PA control circuit 61.

This makes it possible to supply the digital control signal D1, which is supplied from the RFIC 3 to the PA control circuit 61, to the semiconductor component 72 and thereby makes it possible to reduce the leakage of transmission signals in the TDD band A into the low-noise amplifiers 21 and 22.

Also, for example, in the radio frequency module 1A according to the present embodiment, the semiconductor component 72 may be connected to the digital control terminal 131 via the semiconductor component 71b instead of, or in addition to, the semiconductor component 71a, and the semiconductor component 71b may include the switch circuit 51A.

This makes it possible to supply the digital control signal D1 for controlling the switch circuit 51A to the semiconductor component 72 and thereby makes it possible to reduce the leakage of transmission signals in the TDD band A into the low-noise amplifiers 21 and 22.

Also, for example, the radio frequency module 1A according to the present embodiment may further include the filter 33 that is connected to the selection terminal 513A and has a pass band including the transmission band of the FDD band B, and the switch circuit 52A that includes the common terminal 520A connected to the power amplifier (PA) 11, the selection terminal 521A connected to the filter 31T, and the selection terminal 522A connected to the filter 33. This makes it possible to support the transmission of signals in the FDD band B.

Also, for example, in the radio frequency module 1A according to the present embodiment, the semiconductor component 72 may be connected to the digital control terminal 131 via the semiconductor component 71c instead of, or in addition to, the semiconductor component 71a, and the semiconductor component 71c may include the switch circuit 52A.

This makes it possible to supply the digital control signal D1 for controlling the switch circuit 52A to the semiconductor component 72 and thereby makes it possible to reduce the leakage of transmission signals in the TDD band A into the low-noise amplifiers 21 and 22.

Also, for example, in the radio frequency module 1A according to the present embodiment, the digital control terminal 131 may be an external connection terminal that receives the digital control signal D1 including a signal for controlling the power amplifier (PA) 11, and the digital control terminal 132 may be an external connection terminal that receives the digital control signal D2 including signals for controlling the low-noise amplifiers 21 and 22. This configuration makes it possible to control the semiconductor component 72 including the low-noise amplifiers 21 and 22 based on the digital control signal D1, which is supplied from the RFIC 3 via the digital control terminal 131 and includes a signal for controlling the power amplifier (PA) 11, in addition to the digital control signal D2 that is supplied from the RFIC 3 via the digital control terminal 132 and includes signals for controlling the low-noise amplifiers 21 and 22.

Also, for example, in the radio frequency module 1A according to the present embodiment, in the first connection state in which a signal in the TDD band A is transmitted and a signal in the reception band of the FDD band B is received, (i) the switch circuit 51A may connect the common terminal 510A to the selection terminals 511A and 513A but not to the selection terminal 512A, and (ii) the low-noise amplifier 21 may be turned off, and the low-noise amplifier 22 may be turned on; and in the second connection state in which a signal in the TDD band A is received and a signal in the reception band of the FDD band B is received, (iii) the switch circuit 51A may connect the common terminal 510A to the selection terminals 512A and 513A but not to the selection terminal 511A, and (iv) the low-noise amplifiers 21 and 22 may be turned on.

Thus, in the first connection state, the low-noise amplifier 21 is turned off. Therefore, even if a transmission signal in the TDD band A leaks into the receive path of the TDD band A, the transmission signal can be prevented from leaking into the receive path of the FDD band B due to the coupling between the low-noise amplifiers 21 and 22. This in turn makes it possible to reduce the degradation of the reception sensitivity in the FDD band B in the simultaneous communication using the TDD band A and the FDD band B.

Also, for example, in the radio frequency module 1A according to the present embodiment, the semiconductor component 72 may further include the switch circuit 53A that includes the common terminal 531A connected to the low-noise amplifier 21, the common terminal 532A connected to the low-noise amplifier 22, the selection terminal 533A connected to the filter 31R, and the selection terminal 534A connected to the filter 32.

This configuration makes it possible to further reduce the leakage of transmission signals in the TDD band A into the receive path of the TDD band A and the receive path of the FDD band B.

For example, the radio frequency module 1A according to the present embodiment may further include the inductor 41 connected between the common terminal 531A and the low-noise amplifier 21 and the inductor 42 connected between the common terminal 532A and the low-noise amplifier 22.

This makes it possible to reduce the signal loss resulting from the impedance mismatching between the low-noise amplifiers 21 and 22 and the switch circuit 53A.

Also, for example, in the radio frequency module 1A according to the present embodiment, in the first connection state in which a signal in the TDD band A is transmitted and a signal in the reception band of the FDD band B is received, (i) the switch circuit 51A may connect the common terminal 510A to the selection terminals 511A and 513A but not to the selection terminal 512A, and (ii) the switch circuit 53A may not connect the common terminal 531A to the selection terminal 533A and may connect the common terminal 532A to the selection terminal 534A; and in the second connection state in which a signal in the TDD band A is received and a signal in the reception band of the FDD band B is received, (iii) the switch circuit 51A may connect the common terminal 510A to the selection terminals 512A and 513A but not to the selection terminal 511A, and (iv) the switch circuit 53A may connect the common terminal 531A to the selection terminal 533A and connect the common terminal 532A to the selection terminal 534A.

With this configuration, in the first connection state, the switch circuit 53A does not connect the common terminal 531A to the selection terminal 533A. Therefore, even if a transmission signal in the TDD band A leaks into the receive path of the TDD band A via the switch circuit 52A, the transmission signal can be prevented from leaking into the receive path of the FDD band B due to the coupling between the low-noise amplifiers 21 and 22 and/or the coupling between the inductors 41 and 42. This in turn makes it possible to reduce the degradation of the reception sensitivity in the FDD band B in the simultaneous communication using the TDD band A and the FDD band B.

### OTHER EMBODIMENTS

Radio frequency modules according to the embodiments of the present disclosure are described above. However, radio frequency modules according to the present disclosure are not limited to those described in the above embodiments. Other embodiments implemented by combining components in the above embodiments, variations obtained by applying various modifications conceivable by a person skilled in the art to the above embodiments without departing from the spirit of the present disclosure, and various devices including the radio frequency modules described above are also included in the present disclosure.

For example, in the circuit configurations of the radio frequency modules according to the above embodiments, additional circuit elements and/or wires may be inserted in paths connecting the circuit elements and the signal paths illustrated in the drawings. For example, an impedance matching circuit may be connected between each of the filters 31 to 33 and the switch circuit 51 and/or between each of the filters 31T, 31R, 32, and 33 and the switch circuit 51A. Also, for example, an impedance matching circuit may be connected between the power amplifier (PA) 11 and the switch circuit 52 and/or the switch circuit 52A. Also, for example, a coupler may be connected between the switch circuit 51 and/or the switch circuit 51A and the antenna connection terminal 100.

In the above embodiments, each of the radio frequency modules 1 and 1A may include one or more power amplifiers (PA) in addition to the power amplifier (PA) 11. In this case, each of the switch circuits 52 and 52A may further include one or more terminals, and the one or more power amplifiers (PA) may be connected to the one or more terminals. This enables the radio frequency modules 1 and 1A to support simultaneous transmission of signals in the TDD band A and the FDD band B.

Also, in the first embodiment described above, the radio frequency module 1 may include one or more filters in addition to the filters 31 to 33. Similarly, in the second embodiment described above, the radio frequency module 1A may include one or more filters in addition to the filters 31T, 31R, 32, and 33. In this case, each of the switch circuits 51, 51A, 52, 52A, 53, and 53A may further include one or more terminals, and the one or more filters may be connected to the one or more terminals.

Features of the radio frequency modules according to the above embodiments are described below.

<1>

A radio frequency module includes a first digital control terminal; a second digital control terminal; an antenna connection terminal; a first semiconductor component connected to the first digital control terminal; a second semiconductor component that is connected to the second digital control terminal and includes a first low-noise amplifier and a second low-noise amplifier; a power amplifier; a first filter with a pass band including a TDD band; a second filter that is connected to the second low-noise amplifier and has a pass band including a reception band of an FDD band usable for simultaneous communication with the TDD band; a first switch circuit including a first common terminal connected to the antenna connection terminal, a first selection terminal connected to the first filter, and a second selection terminal connected to the second filter; and a second switch circuit including a second common terminal connected to the first filter, a third selection terminal connected to the power amplifier, and a fourth selection terminal connected to the first low-noise amplifier. The second semiconductor component is also connected to the first digital control terminal via the first semiconductor component.

<2>

In the radio frequency module described in <1>, the first semiconductor component includes a PA control circuit.

<3>

In the radio frequency module described in <1>, the first semiconductor component includes the first switch circuit.

<4>

In the radio frequency module described in <1>, the first semiconductor component includes the second switch circuit.

<5>

In the radio frequency module described in any one of <1> to <4>, the first digital control terminal is an external connection terminal that receives a first digital control signal including a signal for controlling the power amplifier; and the second digital control terminal is an external connection terminal that receives a second digital control signal including signals for controlling the first low-noise amplifier and the second low-noise amplifier.

<6>

In the radio frequency module described in any one of <1> to <5>, in a first connection state in which a signal in the TDD band is transmitted, and a signal in a reception band of the FDD band is received, (i) the first switch circuit connects the first common terminal to the first selection terminal and the second selection terminal, (ii) the second switch circuit connects the second common terminal to the third selection terminal but not to the fourth selection terminal, and (iii) the first low-noise amplifier is turned off, and the second low-noise amplifier is turned on; and in a second connection state in which a signal in the TDD band is received, and a signal in the reception band of the FDD band is received, (iv) the first switch circuit connects the first common terminal to the first selection terminal and the second selection terminal, (v) the second switch circuit connects the second common terminal to the fourth selection terminal but not to the third selection terminal; and (vi) the first low-noise amplifier and the second low-noise amplifier are turned on.

<7>

In the radio frequency module described in any one of <1> to <6>, the second semiconductor component further includes a third switch circuit that includes a third common terminal connected to the first low-noise amplifier, a fourth common terminal connected to the second low-noise amplifier, a fifth selection terminal connected to the fourth selection terminal, and a sixth selection terminal connected to the second filter.

<8>

The radio frequency module described in <7> further includes a first inductor connected between the third common terminal and the first low-noise amplifier; and a second inductor connected between the fourth common terminal and the second low-noise amplifier.

<9>

In the radio frequency module described in <7> or <8>, in a first connection state in which a signal in the TDD band is transmitted, and a signal in a reception band of the FDD band is received, (i) the first switch circuit connects the first common terminal to the first selection terminal and the second selection terminal, (ii) the second switch circuit connects the second common terminal to the third selection terminal but not to the fourth selection terminal, and (iii) the third switch circuit does not connect the third common terminal to the fifth selection terminal and connects the fourth common terminal to the sixth selection terminal; and in a second connection state in which a signal in the TDD band is received, and a signal in the reception band of the FDD band is received, (iv) the first switch circuit connects the first common terminal to the first selection terminal and the second selection terminal, (v) the second switch circuit connects the second common terminal to the fourth selection terminal but not to the third selection terminal, and (vi) the third switch circuit connects the third common terminal to the fifth selection terminal and connects the fourth common terminal to the sixth selection terminal.

<10>

The radio frequency module described in any one of <1> to <9> further includes a third filter that is connected to the second selection terminal and has a pass band including a transmission band of the FDD band. The second switch circuit further includes a fifth common terminal connected to the third filter.

<11>

A radio frequency module includes a first digital control terminal; a second digital control terminal; an antenna connection terminal; a first semiconductor component connected to the first digital control terminal; a second semiconductor component that is connected to the second digital control terminal and includes a first low-noise amplifier and a second low-noise amplifier; a power amplifier; a first filter that is connected to the power amplifier and has a pass band including a TDD band; a second filter that is connected to the first low-noise amplifier and has a pass band including the TDD band; a third filter that is connected to the second low-noise amplifier and has a pass band including a reception band of an FDD band usable for simultaneous communication with the TDD band; and a first switch circuit including a first common terminal connected to the antenna connection terminal, a first selection terminal connected to the first filter, a second selection terminal connected to the second filter, and a third selection terminal connected to the third filter. The second semiconductor component is also connected to the first digital control terminal via the first semiconductor component.

<12>

In the radio frequency module described in <11>, the first semiconductor component includes a PA control circuit.

<13>

In the radio frequency module described in <11>, the first semiconductor component includes the first switch circuit.

<14>

The radio frequency module described in <11> further includes a fourth filter that is connected to the third selection terminal and has a pass band including a transmission band of the FDD band; and a second switch circuit including a second common terminal connected to the power amplifier, a fourth selection terminal connected to the first filter, and a fifth selection terminal connected to the fourth filter.

<15>

In the radio frequency module described in <14>, the first semiconductor component includes the second switch circuit.

<16>

In the radio frequency module described in any one of <11> to <15>, the first digital control terminal is an external connection terminal that receives a first digital control signal including a signal for controlling the power amplifier; and the second digital control terminal is an external connection terminal that receives a second digital control signal including signals for controlling the first low-noise amplifier and the second low-noise amplifier.

<17>

In the radio frequency module described in any one of <11> to <16>, in a first connection state in which a signal in the TDD band is transmitted, and a signal in a reception band of the FDD band is received, (i) the first switch circuit connects the first common terminal to the first selection terminal and the third selection terminal but not to the second selection terminal, and (ii) the first low-noise amplifier is turned off, and the second low-noise amplifier is turned on; and in a second connection state in which a signal in the TDD band is received, and a signal in the reception band of the FDD band is received, (iii) the first switch circuit connects the first common terminal to the second selection terminal and the third selection terminal but not to the first selection terminal, and (iv) the first low-noise amplifier and the second low-noise amplifier are turned on.

<18>

In the radio frequency module described in any one of <11> to <17>, the second semiconductor component further includes a third switch circuit that includes a third common terminal connected to the first low-noise amplifier, a fourth common terminal connected to the second low-noise amplifier, a sixth selection terminal connected to the second filter, and a seventh selection terminal connected to the third filter.

<19>

The radio frequency module described in <18> further includes a first inductor connected between the third common terminal and the first low-noise amplifier; and a second inductor connected between the fourth common terminal and the second low-noise amplifier.

<20>

In the radio frequency module described in <18> or <19>, in a first connection state in which a signal in the TDD band is transmitted, and a signal in a reception band of the FDD band is received, (i) the first switch circuit connects the first common terminal to the first selection terminal and the third selection terminal but not to the second selection terminal, and (ii) the third switch circuit does not connect the third common terminal to the sixth selection terminal and connects the fourth common terminal to the seventh selection terminal; and in a second connection state in which a signal in the TDD band is received, and a signal in the reception band of the FDD band is received, (iii) the first switch circuit connects the first common terminal to the second selection terminal and the third selection terminal but not to the first selection terminal, and (iv) the third switch circuit connects the third common terminal to the sixth selection terminal and connects the fourth common terminal to the seventh selection terminal.

The present invention can be widely used for communication devices, such as mobile phones, as a radio frequency module disposed in a front-end unit.

What is claimed is:

1. A radio frequency module comprising:
a first digital control terminal;
a second digital control terminal;
an antenna connection terminal;
a first semiconductor component connected to the first digital control terminal;
a second semiconductor component that is connected to the second digital control terminal and includes a first low-noise amplifier and a second low-noise amplifier;
a power amplifier;
a first filter with a pass band including a time division duplex (TDD) band;
a second filter that is connected to the second low-noise amplifier and has a pass band including a reception band of a frequency division duplex (FDD) band usable for simultaneous communication with the TDD band;
a first switch circuit including a first common terminal connected to the antenna connection terminal, a first selection terminal connected to the first filter, and a second selection terminal connected to the second filter; and
a second switch circuit including a second common terminal connected to the first filter, a third selection terminal connected to the power amplifier, and a fourth selection terminal connected to the first low-noise amplifier, wherein
the second semiconductor component is also connected to the first digital control terminal via the first semiconductor component.

2. The radio frequency module according to claim 1, wherein
the first semiconductor component includes a power amplifier control circuit.

3. The radio frequency module according to claim 1, wherein
the first semiconductor component includes the first switch circuit.

4. The radio frequency module according to claim 1, wherein
the first semiconductor component includes the second switch circuit.

5. The radio frequency module according to claim 1, wherein
the first digital control terminal is an external connection terminal that receives a first digital control signal including a signal for controlling the power amplifier; and
the second digital control terminal is an external connection terminal that receives a second digital control signal including signals for controlling the first low-noise amplifier and the second low-noise amplifier.

6. The radio frequency module according to claim 1, wherein
in a first connection state in which a signal in the TDD band is transmitted, and a signal in a reception band of the FDD band is received,
(i) the first switch circuit connects the first common terminal to the first selection terminal and the second selection terminal,
(ii) the second switch circuit connects the second common terminal to the third selection terminal but not to the fourth selection terminal, and
(iii) the first low-noise amplifier is turned off, and the second low-noise amplifier is turned on; and
in a second connection state in which a signal in the TDD band is received, and a signal in the reception band of the FDD band is received,
(iv) the first switch circuit connects the first common terminal to the first selection terminal and the second selection terminal,
(v) the second switch circuit connects the second common terminal to the fourth selection terminal but not to the third selection terminal; and
(vi) the first low-noise amplifier and the second low-noise amplifier are turned on.

7. The radio frequency module according to any claim 1, wherein
the second semiconductor component further includes a third switch circuit that includes a third common terminal connected to the first low-noise amplifier, a fourth common terminal connected to the second low-noise amplifier, a fifth selection terminal connected to the fourth selection terminal of the second switch circuit, and a sixth selection terminal connected to the second filter.

8. The radio frequency module according to claim 7, further comprising:
a first inductor connected between the third common terminal and the first low-noise amplifier; and
a second inductor connected between the fourth common terminal and the second low-noise amplifier.

9. The radio frequency module according to claim 7, wherein
in a first connection state in which a signal in the TDD band is transmitted, and a signal in a reception band of the FDD band is received,
(i) the first switch circuit connects the first common terminal to the first selection terminal and the second selection terminal,
(ii) the second switch circuit connects the second common terminal to the third selection terminal but not to the fourth selection terminal, and
(iii) the third switch circuit does not connect the third common terminal to the fifth selection terminal and connects the fourth common terminal to the sixth selection terminal; and
in a second connection state in which a signal in the TDD band is received, and a signal in the reception band of the FDD band is received,
(iv) the first switch circuit connects the first common terminal to the first selection terminal and the second selection terminal,
(v) the second switch circuit connects the second common terminal to the fourth selection terminal but not to the third selection terminal, and
(vi) the third switch circuit connects the third common terminal to the fifth selection terminal and connects the fourth common terminal to the sixth selection terminal.

10. The radio frequency module according to claim 1, further comprising:
a third filter that is connected to the second selection terminal and has a pass band including a transmission band of the FDD band, wherein
the second switch circuit further includes a fifth common terminal connected to the third filter.

11. A radio frequency module comprising:
a first digital control terminal;
a second digital control terminal;
an antenna connection terminal;
a first semiconductor component connected to the first digital control terminal;
a second semiconductor component that is connected to the second digital control terminal and includes a first low-noise amplifier and a second low-noise amplifier;
a power amplifier;
a first filter that is connected to the power amplifier and has a pass band including a time division duplex (TDD) band;
a second filter that is connected to the first low-noise amplifier and has a pass band including the TDD band;
a third filter that is connected to the second low-noise amplifier and has a pass band including a reception band of a frequency division duplex (FDD) band usable for simultaneous communication with the TDD band; and
a first switch circuit including a first common terminal connected to the antenna connection terminal, a first selection terminal connected to the first filter, a second selection terminal connected to the second filter, and a third selection terminal connected to the third filter, wherein
the second semiconductor component is also connected to the first digital control terminal via the first semiconductor component.

12. The radio frequency module according to claim 11, wherein
the first semiconductor component includes a power amplifier control circuit.

13. The radio frequency module according to claim 11, wherein
the first semiconductor component includes the first switch circuit.

14. The radio frequency module according to claim 11, further comprising:
a fourth filter that is connected to the third selection terminal and has a pass band including a transmission band of the FDD band; and
a second switch circuit including a second common terminal connected to the power amplifier, a fourth selection terminal connected to the first filter, and a fifth selection terminal connected to the fourth filter.

15. The radio frequency module according to claim 14, wherein
the first semiconductor component includes the second switch circuit.

16. The radio frequency module according to claim 11, wherein
the first digital control terminal is an external connection terminal that receives a first digital control signal including a signal for controlling the power amplifier; and
the second digital control terminal is an external connection terminal that receives a second digital control signal including signals for controlling the first low-noise amplifier and the second low-noise amplifier.

17. The radio frequency module described in claim 11, wherein
in a first connection state in which a signal in the TDD band is transmitted, and a signal in a reception band of the FDD band is received,
(i) the first switch circuit connects the first common terminal to the first selection terminal and the third selection terminal but not to the second selection terminal, and
(ii) the first low-noise amplifier is turned off, and the second low-noise amplifier is turned on; and
in a second connection state in which a signal in the TDD band is received, and a signal in the reception band of the FDD band is received,
(iii) the first switch circuit connects the first common terminal to the second selection terminal and the third selection terminal but not to the first selection terminal, and
(iv) the first low-noise amplifier and the second low-noise amplifier are turned on.

18. The radio frequency module according to claim 11, wherein
the second semiconductor component further includes a third switch circuit that includes a third common terminal connected to the first low-noise amplifier, a fourth common terminal connected to the second low-noise amplifier, a sixth selection terminal connected to the second filter, and a seventh selection terminal connected to the third filter.

19. The radio frequency module according to claim 18, further comprising:
a first inductor connected between the third common terminal and the first low-noise amplifier; and
a second inductor connected between the fourth common terminal and the second low-noise amplifier.

20. The radio frequency module according to claim 18, wherein
in a first connection state in which a signal in the TDD band is transmitted, and a signal in a reception band of the FDD band is received,
(i) the first switch circuit connects the first common terminal to the first selection terminal and the third selection terminal but not to the second selection terminal, and
(ii) the third switch circuit does not connect the third common terminal to the sixth selection terminal and connects the fourth common terminal to the seventh selection terminal; and
in a second connection state in which a signal in the TDD band is received, and a signal in the reception band of the FDD band is received,
(iii) the first switch circuit connects the first common terminal to the second selection terminal and the third selection terminal but not to the first selection terminal, and
(iv) the third switch circuit connects the third common terminal to the sixth selection terminal and connects the fourth common terminal to the seventh selection terminal.
